(19) United States
(12) Patent Application Publication
(10) Pub. No.: US 2025/0328451 A1
(43) Pub. Date: Oct. 23, 2025

(54) MEMORY SYSTEMS, SYSTEMS, RECORDING METHODS AND PRINTING METHODS OF BINARY LOGS, COMPUTER-READABLE STORAGE MEDIUMS, AND COMPUTER PROGRAM PRODUCTS

(71) Applicant: Yangtze Memory Technologies Co., Ltd., Wuhan (CN)

(72) Inventor: Ao Huang, Wuhan (CN)

(21) Appl. No.: 18/782,983

(22) Filed: Jul. 24, 2024

(30) Foreign Application Priority Data
Apr. 22, 2024 (CN) 202410489182.7

(51) Int. Cl. G06F 11/36; G06F 11/07

(52) U.S. Cl. CPC G06F 11/3636; G06F 11/0775; G06F 11/366

(57) ABSTRACT

An example memory system includes: a memory configured to store a first instruction set for performing an operation for tracing an event during firmware running; and one or more processors coupled with the memory and configured to perform the first instruction set, wherein the first instruction set includes instructions that are able to cause the memory system to perform at least the following operations: in response to triggering of a binary log including a plurality of event items, determining a timestamp and a format string describing an event, which are included in each of the plurality of event items, wherein the event items belong to events that occur during running of firmware in the memory system; and recording, as the binary log, at least a compilation address of a local static variable corresponding to the format string describing an event and the timestamp of each event item.

### CROSS-REFERENCE TO RELATED APPLICATION

The present disclosure claims the benefit of priority to China Application No. 202410489182.7, filed on Apr. 22, 2024, the content of which is incorporated herein by reference in its entirety.

### TECHNICAL FIELD

Examples of the present application relate to a technical field of semiconductors, and in example to memory systems, systems, recording methods and printing methods of binary logs, computer-readable storage mediums, and computer program products.

### BACKGROUND

In order to conveniently analyze and debug a memory system, the memory system needs to store a log file.

### BRIEF DESCRIPTION OF THE DRAWINGS

FIG. 1 is a schematic diagram of an example system having a memory system according to an example of the present application;

FIG. 2A is a schematic diagram of an example memory card having a memory system according to an example of the present application;

FIG. 2B is a schematic diagram of an example solid-state drive having a memory system according to an example of the present application;

FIG. 3 is a schematic diagram of an example memory comprising a peripheral circuit according to an example of the present application;

FIG. 4 is a schematic diagram of an example composition structure having a memory system provided by an example of the present application;

FIG. 5 is a schematic diagram of a firmware event tracer configured for a memory device of a memory system according to an example of the present application;

FIG. 6 is a flow diagram of an example recording method of a binary log having a memory system according to an example of the present application;

FIG. 7 is a flow diagram of an example printing method of a binary log having a memory system according to an example of the present application;

FIG. 8 is a flow diagram of another example printing method of a binary log having a memory system according to an example of the present application; and

FIG. 9 is a schematic diagram of a composition structure of a computer-readable storage medium provided by examples of the present application.

### DETAILED DESCRIPTION

The technical solutions in implementations of the present application will be described below clearly and completely in conjunction with the implementations and the drawings of the present application. It is apparent that the implementations described are only part of, but not all of, the implementations of the present application. All other implementations obtained by those of ordinary skill in the art on the basis of the implementations in the present application without creative work all fall within the scope of protection of the present application.

In the following descriptions, a lot of details are given in order to provide the more thorough understanding of the present application. However, it is apparent to a person skilled in the art that the present application may be implemented without one or more of these details. In other examples, in order to avoid confusion with the present application, some technical features well-known in the field are not described. Namely, all the features of the actual examples are not described here, and well-known functions and structures are not described in detail.

A purpose of the terms used here is only to describe the examples and not as limitation to the present application. As used herein, unless otherwise indicated expressly in the context, “a”, “one” and “the” in a singular form are also intended to include a plural form. It is to be further understood that terms “comprised of” and/or “comprise”, when used in this specification, determine the presence of the described features, integers, steps, operations, elements and/or components, but do not preclude the presence or addition of one or more of other features, integers, steps, operations, elements, components, and/or groups. As used herein, the term “and/or” includes any and all combinations of related items listed.

In order to understand the present application thoroughly, detailed operations and detailed structures are presented in the following description, so as to explain the technical solutions of the present application. Preferred examples of the present application are described in detail below, however, the present application may also have other implementations in addition to these detailed descriptions.

A memory device in examples of the present application includes, but is not limited to, a three-dimensional NAND memory. For ease of understanding, the three-dimensional NAND memory is used as an example for description.

A large number of log files may affect program running efficiency, and a data volume of the log file may also form a challenge to the storage resource of the memory system.

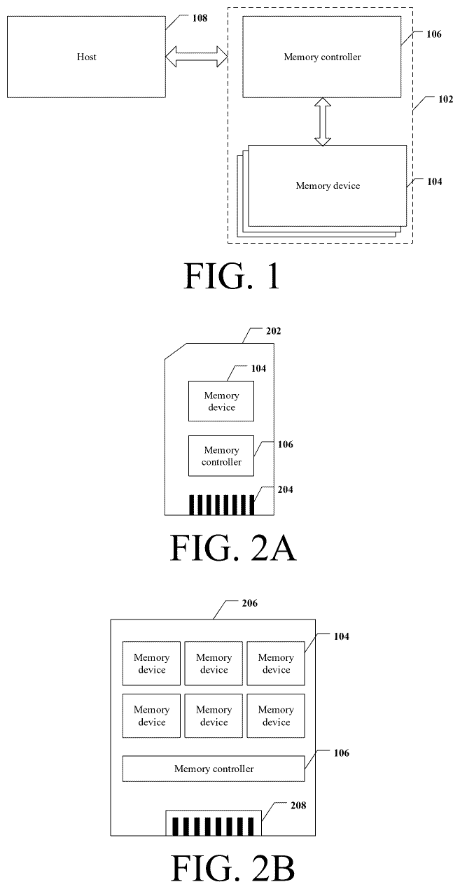

FIG. 1 shows a block diagram of an example system 100 having a memory device according to some aspects of the present application. The system 100 may comprise a mobile phone, a desktop computer, a laptop computer, a tablet computer, a vehicle computer, a gaming console, a printer, a positioning apparatus, a wearable electronic apparatus, a smart sensor, a virtual reality (VR) apparatus, an augmented reality (AR) apparatus, or any other suitable electronic apparatus having a memory. As shown in FIG. 1, the system 100 may comprise a host 108 and a memory system 102, and the memory system 102 is provided with one or more memory devices 104 and a memory controller 106. The host 108 may be a processor of an electronic apparatus (e.g., a central processing unit (CPU)) or a system on chip (SoC) (such as an application processor (AP)). The host 108 may be configured to send or receive data to or from the memory device 104.

According to some implementations, the memory controller 106 is coupled to the memory device 104 and the host 108, and is configured to control the memory device 104. The memory controller 106 may manage data stored in the memory device 104, and communicate with the host 108. In some implementations, the memory controller 106 is designed for operating in a low duty-cycle environment, such as secure digital (SD) cards, compact flash (CF) cards, universal serial bus (USB) flash drives, or other media for use in electronic apparatuses, such as personal computers, digital cameras, mobile phones, etc.

In some implementations, the memory controller 106 is designed for operating in a high duty-cycle environment of solid state disks (SSD) or embedded multi-media cards (eMMC) used as data memories for mobile apparatuses, such as smartphones, tablets, laptop computers, etc., and enterprise memory arrays.

The memory controller 106 may be configured to control operations of the memory device 104, such as read, erase, and program operations. The memory controller 106 may further be configured to manage various functions with respect to data stored or to be stored in the memory device 104, including, but not limited to, bad-block management, garbage collection, logical-to-physical address translation, wear leveling, etc. In some implementations, the memory controller 106 is further configured to process error correction codes with respect to the data read from or written to the memory device 104.

The memory controller 106 may further perform any other suitable functions, for example, formatting the memory device 104. The memory controller 106 may communicate with an external apparatus (e.g., the host 108) according to a communication protocol. For example, the memory controller 106 may communicate with the external apparatus through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

The memory controller 106 and the one or more memory devices 104 can be integrated into various types of storage apparatuses, for example, be comprised in the same package (such as a universal flash storage (UFS) package or an eMMC package). That is to say, the memory system 102 may be implemented and packaged into different types of end electronic products.

In one example shown in FIG. 2A, the memory controller 106 and the single memory device 104 may be integrated into a memory card 202. The memory card 202 may comprise a personal computer memory card international association (PCMCIA, PC) card, a CF card, a smart media (SM) card, a memory stick, a multimedia card (MMC, RS-MMC, MMCmicro), an SD card (SD, miniSD, microSD, SDHC), a UFS, etc. The memory card 202 may further comprise a memory card connector 204 coupling the memory card 202 with a host (e.g., the host 108 in FIG. 1).

In another example as shown in FIG. 2B, the memory controller 106 and the plurality of memory devices 104 may be integrated into an SSD 206. The SSD 206 may further comprise an SSD connector 208 coupling the SSD 206 with a host (e.g., the host 108 in FIG. 1). In some implementations, at least one of a storage capacity or an operation speed of the SSD 206 is greater than at least one of a storage capacity or an operation speed of the memory card 202.

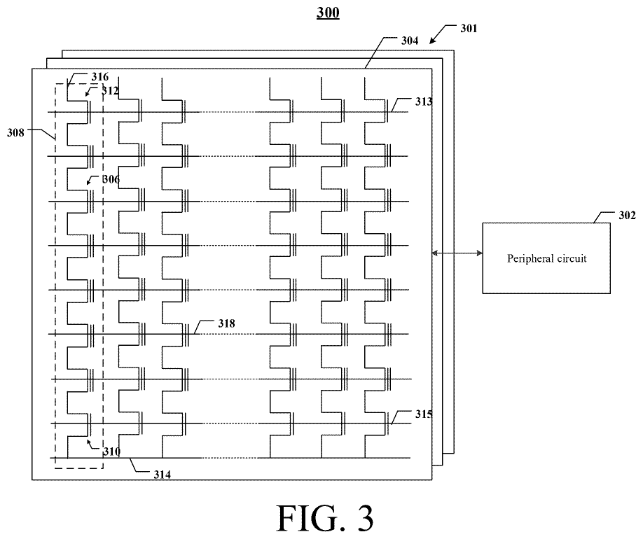

FIG. 3 shows a schematic circuit diagram of an example memory device 300 comprising a peripheral circuit according to some aspects of the present application. The memory device 300 may be an example of the memory device 104 in FIG. 1. The memory device 300 may comprise a memory cell array 301 and a peripheral circuit 302 coupled to the memory cell array 301. For example, the memory cell array 301 is a three-dimensional NAND memory array, wherein a memory cell 306 is a NAND memory cell; the memory cell 306 is provided in the form of an array of memory strings 308; and each memory string 308 extends vertically above a substrate (not shown). In some implementations, each memory string 308 comprises a plurality of memory cells 306 coupled in series and stacked vertically. Each memory cell 306 may maintain a continuous analog value, such as voltage or charge, which depends on the number of electrons trapped within a region of the memory cells 306. Each memory cell 306 may be either a floating gate type memory cell comprising a floating gate transistor, or a charge trapping type memory cell comprising a charge trapping transistor.

In some implementations, each memory cell 306 is a single-level cell (SLC) that has two possible memory states and thus may store one bit of data. For example, a first memory state “0” may correspond to a first voltage range, and a second memory state “1” may correspond to a second voltage range. In some implementations, each memory cell 306 is a multi-level cell (MLC) that can store more than one bit of data in more than four memory states. For example, the MLC can store two bits per cell (which may also be called a double-level cell), three bits per cell (also called a trinary-level cell (TLC)), four bits per cell (also called a quad-level cell (QLC)), five bits per cell (also called a penta-level cell (PLC)), or more than five bits per cell. Each MLC can be programmed to assume a range of possible nominal storage values. In one example, if each MLC stores two bits of data, the MLC can be programmed to employ one of three possible programmed levels from an erased state by writing one of three possible nominal storage values to the cell, and a fourth nominal storage value may be used to represent the erased state.

It is to be noted that, the memory state described here is the memory state of the memory cell described in the present application. Different memory cells have different numbers of memory states. For example, the SLC-type memory cell has 2 memory states (i.e., two states of memory), wherein the 2 memory states comprise one programmed state and one erased state. For another example, the MLC-type memory cell has 4 memory states, wherein the 4 memory states comprise one erased state and three programmed states. For yet another example, the TLC-type memory cell has 8 memory states, wherein the 8 memory states comprise one erased state and seven programmed states. In some implementations, the QLC-type memory cell has 16 memory states, wherein the 16 memory states comprise one erased state and fifteen programmed states.

As shown in FIG. 3, each memory string 308 may comprise a bottom select transistor 310 (BSG, also referred to as a source side select transistor) at a source terminal of the memory string and a top select transistor 312 (TSG, also referred to as a drain side select transistor) at a drain terminal of the memory string. The BSG 310 and the TSG 312 may be configured to activate a selected memory string 308 during read and program operations. In some implementations, sources of memory strings 308 in a same block 304 are coupled through a same source line (SL) 314 (e.g., a common SL). In other words, according to some implementations, all the memory strings 308 in the same block 304 have an array common source (ACS). According to some implementations, the TSG 312 of each memory string 308 is coupled to a respective bit line (BL) 316, and data may be read or written from the bit line 316 via an output bus (not shown). In some implementations, each memory string 308 is configured to be selected or unselected by applying a select voltage (e.g., above a threshold voltage of a transistor having the TSG 312) or an unselect voltage (e.g., 0 V) to the respective TSG 312 via one or more TSG lines 313 and/or by applying a select voltage (e.g., above a threshold voltage of a transistor having the BSG 310) or an unselect voltage (e.g., 0 V) to the respective BSG 310 via one or more BSG lines 315.

As shown in FIG. 3, the memory strings 308 may be organized into a plurality of blocks 304, and each of the plurality of blocks 304 may have a common source line 314 (e.g., coupled to the ground). In some implementations, each block 304 is a basic data unit for an erase operation, i.e., all of the memory cells 306 on the same block 304 are erased at the same time. In order to erase the memory cells 306 in a selected block 304, the source lines 314 coupled to the selected block 304 as well as unselected blocks 304 that are in the same plane as the selected block 304 can be biased with an erase voltage (Vers, such as a high positive voltage (e.g., 20 V or higher)). It is to be understood that in some examples, the erase operation may be performed at a half block level, a quarter block level, or a level having any suitable number of blocks or any suitable fractions of a block. The memory cells 306 of adjacent ones of the memory strings 308 may be coupled through word lines 318 that select which row of memory cells 306 is affected by the read and program operations.

Referring to FIG. 3, each of the plurality of memory cells 306 is coupled to the respective word line 318, and each memory string 308 is coupled to the respective bit line 316 through a respective select transistor (such as, the top select transistor (TSG) 312).

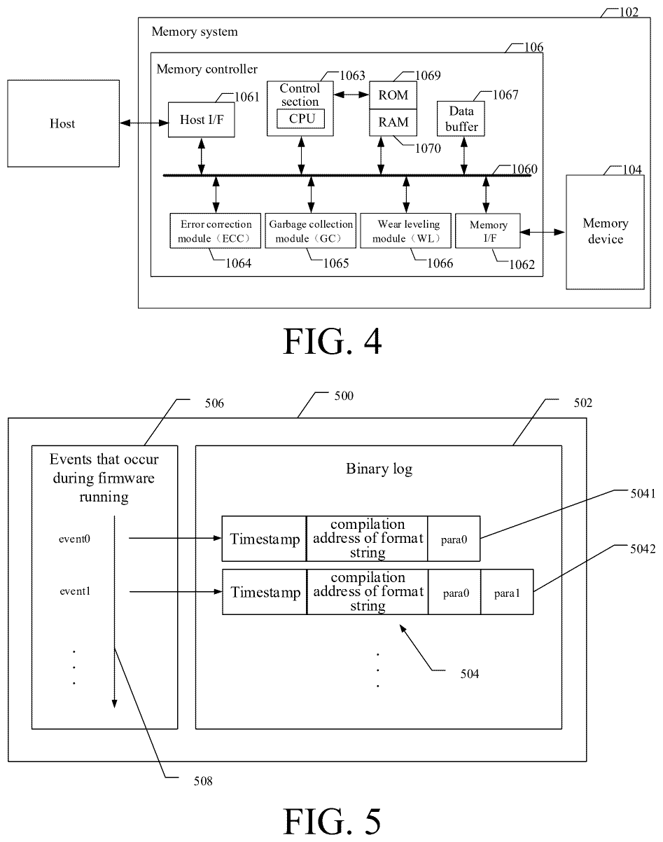

Referring to FIG. 4, in some examples, the memory system 102 is coupled with a host, and performs a variety of feedback in response to instructions of the host. The memory system 102 may comprise the memory controller 106 and the memory device 104, wherein the memory controller 106 is configured to control the memory device 104 to perform operations of read, write, erase, etc.; and the memory controller 106 and the memory device 104 may also be coupled in any suitable manners.

The memory controller 106 may comprise a host interface (I/F) 1061, a memory interface (I/F) 1062, a control section 1063, a read-only memory (ROM) 1069, a random access memory (RAM) 1070, an error correcting module 1064, a garbage collection module 1065, a wear leveling module 1066, a data buffer 1067, and a bus 1060. The host interface 1061 is a connection interface connecting the host 108 and the memory controller 106; and the host interface 1061 allows the host and the memory controller to communicate according to a protocol, send read and write requests, and perform other operations. The memory interface 1062 is a connection interface between the memory controller 106 and the memory device 104; and the memory interface 1062 is configured to implement data transmission between the memory controller 106 and the memory device 104. The control section 1063 is configured to integrally control the memory system 102, and the aforementioned operations performed by the memory controller are mainly performed and completed by the control section 1063 here. In some examples, the control section 1063 is, for example, a central processing unit (CPU), a micro-processing unit (MCU), etc. The ROM 1069 usually comprises firmware or firmware program codes of the memory controller 106. These codes are used for initializing and operating various components of the memory controller, and the RAM 1070 is usually configured to buffer data. The error correction module 1064 may further comprise an encoding section and a decoding section. The encoding section is configured to encode data to be stored, so as to obtain check data, and the decoding section is configured to decode the check data to detect and correct possible error data in a process of data transmission.

The garbage collection module 1065 is configured to: after a storage space of the memory device reaches a certain threshold, read out valid data in some blocks, perform rewrite, and then label these blocks, to obtain new spare blocks. A general implementation of garbage collection may comprise three operations: selecting a source block with a small amount of valid data; finding the valid data from the source block; and writing the valid data to a target block. In this case, all data in the source block becomes invalid data; and the source block is labeled, and may be used as a new spare block. The wear leveling module 1066 is configured to level wear (a number of erase times) of each block in the memory system through data statistics and algorithms. A general implementation of wear leveling may comprise two operations: selecting a source block in which cold data is located; and reading valid data in the source block and writing same to a block with a relatively large number of erase times. In this case, the valid data in the source block becomes invalid data, and the source block is labeled. The data buffer 1067 is configured to buffer data.

In the field of memory systems, for example, in the field of memories such as Solid State Drives (SSDs), for ease of debugging and troubleshooting of the memory system, firmware (FW) usually needs to add log statements in codes to output various parameters and information during program running, i.e., log files. The log files also need to be stored for analysis and debugging. However, a large number of log files may affect program running efficiency, and a data volume of the log file may also form a challenge to the storage resource of the memory system. Therefore, the log files need to be recorded and stored by employing a compression solution, so as to solve a contradiction between the number of log files and program running efficiency and log file storage.

In some examples, each log statement is replaced with an identifier (ID); and during program running, a dynamic parameter of the identifier is dumped. That is to say, in these examples, a generation solution of an identifier is required, and the identifier needs to be generated by an extra tool, and even needs to be modified and replaced to a certain extent by a source code. Moreover, tools are also required to scan the source code to generate a format string file. This means extra effort is required to maintain a version association between the format string file and the firmware.

In view of this, examples of the present application provide a memory system, a system, a recording method and printing method of a binary log, a computer-readable storage medium, and a computer program product.

In a first aspect, examples of the present application provide a memory system. The memory system comprises: a memory configured to store a first instruction set for performing an operation for tracing an event during firmware running; and one or more processors coupled with the memory and configured to perform the first instruction set, wherein the first instruction set comprises instructions that are able to cause the memory system to perform at least the following operations: in response to triggering of a binary log comprising a plurality of event items, determining a timestamp and a format string describing an event, which are comprised in each of the plurality of event items, wherein the event items belong to events that occur during running of firmware in the memory system; and recording, as the binary log, at least a compilation address of a local static variable corresponding to the format string describing an event and the timestamp of each event item.

In some examples, the memory system comprises a memory card or a solid state disk.

Herein, a structure of the memory system may be understood by referring to the aforementioned related descriptions for the memory system 102 in FIGS. 1 and 4, and is not described herein again.

Herein, the memory may be understood by referring to the memory device 104 in FIG. 4.

Herein, the processor may be understood by referring to the memory controller 106 in FIG. 4. The memory controller 106 is configured to integrally control the memory system 102.

In some examples, the memory system may be provided with one or more memories and processors; the processors are coupled to the memories, and configured to control the memories; and the processors may manage data stored in the memories.

In some examples, the firmware may be an electrically erasable programmable ROM (EEPROM) or a FLASH chip stored in the memory system, and may perform an upgrade program by a host through a refresh program. The firmware controls read/write and transmission algorithms of the memory system, and rationally assigns the storage of data.

In an example, in a C language, before a program runs, a compiler manages variable information through a symbol table, comprising the names, types, addresses, etc. of variables. In a compilation process, the compiler assigns a memory space for each variable, and assigns one unique compilation address.

The compilation address of the variable is dynamically assigned by the compiler during program running. A detailed assignment mode of the compilation address of the variable depends on the type of the variable. For a global static variable, a memory space is assigned in a data segment of a program or a memory area (Block Started by Symbol), and a compilation address has been already determined before program running, wherein the compilation address is fixed during program running. For the local static variable, the memory space is assigned in a stack frame, and is dynamically assigned and released when a function is called; each time the function is called, a memory space is assigned for a local static variable of the function; and after the performing of the function is completed, the memory spaces of these variables are released, and the compilation addresses may vary each time the function is called.

In the examples of the present application, the compilation address of the local static variable is assigned by the compiler, the compilation address is unique and serves as the identifier; meanwhile, during firmware running, there are more events, and the compilation address assigned for the local static variable is dynamically assigned and released when the function is called, and does not occupy the memory space all the time, such that the local static variable can well meet the uniqueness of the event and does not occupy too much memory.

A format string comprises a string of placeholders, which is a new string with a fixed format generated after an existing string is embedded according to a specified template. The format string is a regular string that is obtained by, in a program process, allowing a coder to integrate or extract relevant corresponding information through the placeholder, comprising a format input and a format output.

The format string is a data format in which several positions (or referred to as placeholders and may be represented by %) are reserved in a string, and these several positions are filled with respective contents according to requirements.

For example, as shown in an example code list (1) below, the format string is “Trace record with 2 arguments: % d, 0x % x\n”, wherein 2% indicate 2 positions reserved; letters immediately following % indicate data types of the reserved positions, for example, d indicates that the data type is decimal; a prefix 0x indicates a hexadecimal; % x represents that an alphabetic symbol for hexadecimal output is lowercase; and \n is the newline character.

When the format string is outputted through a format output function printf, two parameters describing events are filled at two placeholders. A log type may be classified into statistics or processes. The former obtains the statistics on the occurrence of internal events, and the latter obtains events having timestamps and parameters. Statistical logs are useful for generic overviews during failure analysis of memory devices, but do not provide exact timestamps, i.e., when and what circumstances did an event occur. In another aspect, process logs provide a complete history of events occurring on the device, but the process logs need more memory spaces. The statistical logs may be implemented by using simple global variable increments, and the process logs may use the timestamps and custom parameters. Here and below, binary logs may be understood as statistical logs.

FIG. 5 is a schematic diagram of a firmware event tracer 500, and shows creating of a binary log 502. The binary log 502 comprises a plurality of event items 504, such as event items 5041, 5042, . . . , etc. Each of the event items 5041, 5042, . . . , etc. comprises a timestamp and a compilation address of a format string.

An event item 504 is generated by performing firmware. In an example, an event 506 occurring during firmware running is shown as having a timeline 508 of events respectively corresponding to the event items 504. For example, events event0, event1, . . . , etc. in the timeline 508 respectively correspond to the event items 5041, 5042, . . . , etc.

In the examples of the present application, each log statement does not need to be replaced with an identifier, and the local static variable is ingeniously utilized; since the compilation address assigned to the local static variable by a compiler is unique, after the compilation address is associated with the format string describing an event, the compilation address may serve as the identifier, such that the identifier does not need to be generated by an extra tool; meanwhile, in the examples of the present application, the compilation address of the local static variable can be obtained directly by compiling a source code without the need of extra processing such as modifying, replacing, scanning, etc. the source code, thereby greatly simplifying processes of log usage, and improving the convenience of tracing by firmware using logs; furthermore, in the examples of the present application, the timestamp of each event item and the compilation address of the local static variable corresponding to the format string describing an event are mainly saved, such that a data volume of logs is minimized.

In some examples, each of the plurality of event items further comprises at least one parameter describing an event; and the binary log further comprises the at least one parameter describing an event.

In the examples of the present application, each of the plurality of event items comprises a timestamp, a compilation address of a format string, and at least one parameter. Referring to FIG. 5, each of the multiple event items 5041, 5042, . . . , etc. may be defined by the timestamp, the compilation address of the format string, and the at least one parameter. The parameter may identify a channel, a die, a plane, a block, a page, a row, or a column. In the examples shown, the event item 5041 has one custom parameter (para0), and the event item 5042 has two custom parameters (para0 and para1). In an example, each of the custom parameters may be of a double word (DWORD) type.

For example, as shown in the example code list (1) below, the parameter describing events are “1, GetGenTimerBaseFreq ( )”, wherein there are two parameters “1” and “GetGenTimerBaseFreq ( )”.

In some examples, the format string describing an event is stored, in the form of the local static variable, in one section of an executable and linkable format (ELF) file in which the firmware is located.

In an example, macro replacement is utilized, and in a compilation process of the firmware, a format string of a binary log is stored, in the form of the local static variable, in one section of the executable and linkable format (ELF) file in which the firmware is located.

In the examples of the present application, since all format strings are in an output section ER_TRACE of the ELF file, a human readable log may be supported to be outputted online. For example, the binary log is directly printed through a serial port command.

Furthermore, in the examples of the present application, the format string describing an event is stored, in the form of the local static variable, in one section of the ELF file in which the firmware is located, an extra format file of the binary logs does not need to be maintained, and any extra effort is not required to maintain a version association between the format string file and the firmware, such that the maintainability of log tracing is improved.

In some examples, the memory comprises a non-volatile memory device; and the binary log is stored in the non-volatile memory device.

In an example, the event items of the binary logs having custom formats (the timestamp, the compilation address of the format string, and the at least one parameter) are initially stored in a volatile memory device.

As shown in the example code list (1) below, an event log point exists in a firmware code to use a tracer, and a timestamp of an event, a compilation address of a format string describing the event, and at least one parameter describing the event are stored in the volatile memory device, and are then dumped in the non-volatile memory device.

FWTRACE (“Trace record with 2 arguments: % d, 0x % x\n”, 1, GetGenTimerBaseFreq( ); (1)

In some examples, the event items of the binary logs are first stored in the volatile memory device, and when the volatile memory device is full, the event items are dumped in the non-volatile memory device.

In some examples, the volatile memory device comprises a dynamic random access memory (DRAM), a synchronous dynamic random-access memory (SDRAM), or a double-data-rate fourth generation synchronous dynamic random access memory (DDR4 SDRAM). In some examples, the volatile memory device may further comprise a static random-access memory (SRAM).

In some examples, the non-volatile memory device may comprise an apparatus of a FLASH chip (e.g., a three-dimensional NAND Flash memory). The FLASH chip may be used as a storage medium of the SSD of the above-mentioned memory system to store data.

In some examples, format strings describing different events correspond to compilation addresses of different local static variables.

In an example, the format strings describing different events are, in the form of different local static variables, stored in one section of the ELF file; for different local static variables, different memory spaces (compilation addresses) are assigned in a stack frame, and are dynamically assigned and released when a function is called; each time the function is called, different memory spaces are assigned for the local static variables of the function; and after the performing of the function is completed, the memory spaces of these variables are released.

In some examples, the first instruction set is implemented through a plurality of macros.

As shown in the example code list (1) above, the first instruction set may be implemented through a group of macros, wherein a core macro is FWTRACE. The core macro FWTRACE converts the format string into the local static variable, and is designated to be stored in one section FW_Traces section of the executable and linkable format (ELF) file in which the firmware is located. “Trace record with 2 arguments: % d, 0x % x\n” of the core macro FWTRACE in the code list (1) indicates that the format string is converted into the local static variable, and is designated to be stored in a section (FW_Traces section) of the ELF file; and “1, GetGenTimerBaseFreq( )” of the core macro FWTRACE in the code list (1) indicates that the timestamp of the event, the compilation address of the format string describing the event, and the at least one parameter describing the event are stored in the volatile memory device, such as a trace buffer.

In the examples of the present application, an Application Programming Interface (API) of the binary log has been packaged into several simple macros, which may be called as simply as the format output function printf.

In some examples, the binary log is configured to perform failure analysis (FA) on the firmware.

For example, a production process of a NAND memory device comprises component design, component integration, product operational stabilization, preparation of engineering samples and customer samples, preparation of approval candidates, volume production, and return merchandise authorization support. The failure analysis of various components is also a part of the production process, and a component performing the failure analysis is the firmware. For example, during volume production, a position of a memory device program page error needs to be acquired by the firmware, as shown in the example code list (1) above, the format string is “Trace record with 2 arguments: % d, 0x % X\n”, wherein a placeholder is “%”, and when the format string is outputted, the two placeholders are configured to be filled with information describing the position of the memory device program page error. For example, the information of the position of the memory device program page error may be represented by the custom parameters. In the examples of the present application, an event with respect to the firmware is traced by using the binary log, and then the firmware may be analyzed by using the binary log, i.e., performing the failure analysis.

In a second aspect, examples of the present application provide another memory system. The memory system comprises: a memory configured to store a second instruction set using a firmware event tracer, wherein the firmware event tracer comprises a plurality of event items, and the event items belong to events that occur during running of firmware in the memory system; and each event item comprises a timestamp and a format string describing an event; and one or more processors coupled with the memory and configured to perform the second instruction set, wherein the second instruction set comprises instructions that are able to cause the memory system to perform at least the following operations: in response to a print command of a binary log, obtaining the format string describing an event according to a compilation address of a local static variable corresponding to a format string in the binary log and in combination with a local static variable stored in an ELF file in which the firmware is located; and outputting the obtained format string and the corresponding timestamp together.

In an example, as shown in the example code list (1) above, the first instruction set may be implemented through a group of macros, wherein a core macro is FWTRACE. The core macro FWTRACE converts the format string into the local static variable, and is designated to be stored in one section FW_Traces section of the executable and linkable format (ELF) file in which the firmware is located; and a timestamp of an event, a compilation address of a format string describing the event, and at least one parameter describing the event are stored in the volatile memory device, and are then dumped in the non-volatile memory device.

As all format strings are in an ER_Traces section of ELF imag, the solution supports online outputting of a human readable log. For example, the binary log is directly printed through a serial port command. In other words, the firmware and the local static variable converted from the format string are all stored in the memory system, and the memory system may conveniently realize a function of printing logs online.

Furthermore, as there is no accompanying format file for the binary log, a binary file for the dumped binary log may be directly analyzed through the ELF file, such that errors are not easy to occur.

In some examples, each of the plurality of event items further comprises at least one parameter describing an event, and the at least one parameter describing an event is filled in a placeholder of the obtained format string describing an event; and when the obtained format string and the corresponding timestamp are outputted together, the filled format string and the corresponding timestamp are outputted together.

In an example, after the logs are saved, the compilation addresses are replaced with the format strings, and dynamic parameters are filled in the placeholders of the format strings and then outputted together with the timestamps. If, for example, the format string is that “the number of bad blocks is % d”, and the placeholder is a parameter, when the log is saved, there may be one compilation address, one parameter (e.g., 5), and one timestamp, then the compilation address is replaced with the format string and the number is put in an appropriate position, and the output format string is that “the number of bad blocks is 5”.

In an example, directly printing the binary log through the serial port command comprises: outputting the filled format string and the corresponding timestamp together.

In a third aspect, examples of the present application provide a system. The system comprises: any one of the memory systems provided in the first aspect and the second aspect; and a host coupled with the memory system and configured to control the memory system.

In some examples, the host may be such as a personal computer, a mobile phone, a GPS end, a digital satellite receiver, etc. In some examples, the memory controller may manage data stored in the memory device. In some implementations, the memory controller is designed for operating in a low duty-cycle environment, such as Secure Digital (SD) cards, Compact Flash (CF) Cards, Universal Serial Bus (USB) flash drives, or other media for use in electronic apparatuses, such as personal computers, digital cameras, mobile phones, etc. In some implementations, the memory device may comprise an apparatus of a FLASH chip (e.g., a three-dimensional NAND Flash memory). The FLASH chip may be used as a storage medium of the SSD of the above-mentioned memory system to store data.

In an example, the memory system comprises: a memory configured to store a first instruction set for performing an operation for tracing an event during firmware running; and one or more processors coupled with the memory and configured to perform the first instruction set, wherein the first instruction set comprises instructions that are able to cause the memory system to perform at least the following operations: in response to triggering of a binary log comprising a plurality of event items, determining a timestamp and a format string describing an event, which are comprised in each of the plurality of event items, wherein the event items belong to events that occur during running of firmware in the memory system; and recording, as the binary log, at least a compilation address of a local static variable corresponding to the format string describing an event and the timestamp of each event item.

In the examples of the present application, after acquiring a log file, the host also needs to acquire the local static variable stored in an ELF file in which the firmware stored in the memory system is located, and then perform analysis by utilizing the acquired local static variable, so as to obtain the format string describing an event, i.e., obtaining a readable log.

In an example, by implementing a second instruction set in a link script of an application, a section (FW_Traces section) of each of the ELF files is collected in an output section of the ELF ile.

As shown in the example code list (2) below, the output section of the ELF file is defined as ER_TRACE:

| ER_TRACE +0 | |
|---|---|
| { | |
| *(FW_Traces) | |
| } | (2) |

In this way, the format string may be directly obtained from the output section ER_TRACE of the ELF file, so as to offline convert the binary log for the format string dumped to the non-volatile memory device into a human readable log.

In some examples, the host is configured to: acquire a binary log and a local static variable stored in an ELF file in which firmware is located, wherein a compilation address of the local static variable corresponds to a format string describing an event; based on the acquired local static variable, parse the compilation address of the local static variable in the binary log, so as to obtain the format string describing an event; and output the obtained format string and the corresponding timestamp together.

In this way, the format string may be directly obtained from the output section ER_TRACE of the ELF file, so as to offline convert the binary log for the format string dumped to the non-volatile memory device into the human readable log.

In some examples, after the binary log is dumped through an interface (e.g., uart, smbus, PCIe, etc.) with the host, the human readable log may be generated in combination with the local static variable converted from the format string stored in a section (FW_Traces section) of the ELF file. In this way, the human readable log may be generated without extra format text files.

In some examples, each of the plurality of event items of the binary log further comprises at least one parameter describing an event, and the at least one parameter describing an event is filled in a placeholder of the obtained format string describing an event; and when the obtained format string and the corresponding timestamp are outputted together, the filled format string and the corresponding timestamp are outputted together.

In an example, after the logs are saved, a compilation address is replaced with a format string, and a dynamic parameter is filled in the placeholder of the format string and then outputted together with the timestamp. If the format string is that “the number of bad blocks is % d”, and the placeholder is a parameter, when the log is saved, there may be a compilation address, a parameter (e.g., 5), and a timestamp, then the compilation address is replaced with the format string and the number is put in an appropriate position, and the output format string is that “the number of bad blocks is 5”.

In an example, generating the readable log by dumping the binary log from the interface of the host and combining the local static variable of the ELF file comprises: outputting the filled format string and the corresponding timestamp together.

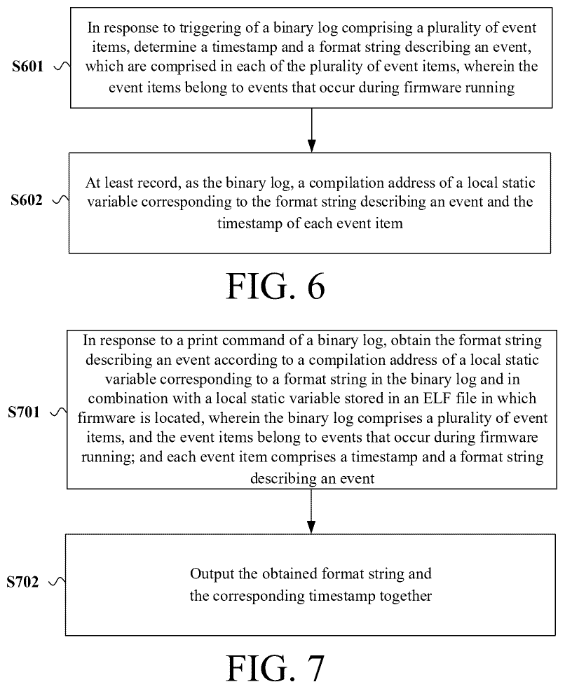

In a fourth aspect, examples of the present application provide a recording method of a binary log. Referring to FIG. 6, the recording method comprises performing the following operations: S601, in response to triggering of a binary log comprising a plurality of event items, determining a timestamp and a format string describing an event, which are comprised in each of the plurality of event items, wherein the event items belong to events that occur during firmware running; and S602, recording, as the binary log, at least a compilation address of a local static variable corresponding to the format string describing an event and the timestamp of each event item.

The memory system utilized by the recording method of a binary log provided in the examples of the present application is the same as or similar to the above-mentioned memory system in various examples of the first aspect. Technical features that are not disclosed in detail in the examples of the present application are understood by referring to the above-mentioned memory system in various examples of the first aspect, and are not described herein again.

In a fifth aspect, examples of the present application provide a printing method of a binary log. Referring to FIG. 7, the printing method comprises performing the following operations: S701, in response to a print command of a binary log, obtaining the format string describing an event according to a compilation address of a local static variable corresponding to a format string in the binary log and in combination with a local static variable stored in an ELF file in which firmware is located, wherein the binary log comprises a plurality of event items, and the event items belong to events that occur during firmware running; and each event item comprises a timestamp and a format string describing an event; and S702, outputting the obtained format string and the corresponding timestamp together.

In the examples of the present application, since all format strings are in an output section of the ELF file, a human readable log may be supported to be outputted online. For example, the binary log is directly printed through a serial port command. Herein, a printing method in this example is referring to as an online printing method.

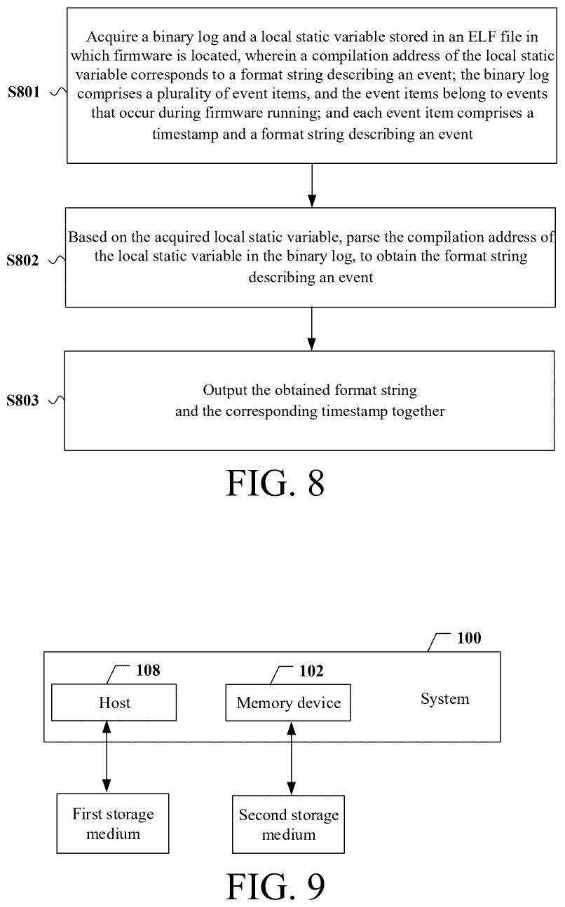

In a sixth aspect, examples of the present application provide another printing method of a binary log. Referring to FIG. 8, the printing method comprises performing the following operations: S801, acquiring a binary log and a local static variable stored in an ELF file in which firmware is located, wherein a compilation address of the local static variable corresponds to a format string describing an event; the binary log comprises a plurality of event items, and the event items belong to events that occur during firmware running; and each event item comprises a timestamp and a format string describing an event; S802, based on the acquired local static variable, parsing the compilation address of the local static variable in the binary log, so as to obtain the format string describing an event; and S803, outputting the obtained format string and the corresponding timestamp together.

In the examples of the present application, a human readable log may be supported to be outputted online, and the format string may also be directly obtained from an output section of an ELF file, so as to offline convert the binary log for the format string dumped to a non-volatile memory device into the human readable log. Herein, a printing method in this example is referred to as an offline printing method.

Referring to FIG. 9, FIG. 9 is a schematic diagram of a composition structure of a computer-readable storage medium provided by examples of the present application. In a seventh aspect, examples of the present application provide a computer-readable storage medium. As shown in FIG. 9, the computer-readable storage medium stores a computer program, and when the computer program is loaded and executed by a processor, the recording method provided in the fourth aspect, the printing method provided in the fifth aspect, or the printing method provided in the sixth aspect is implemented.

In some examples, the computer-readable storage medium may be a Ferromagnetic Random Access Memory (FRAM), a Read Only Memory (ROM), a Programmable Read-Only Memory (PROM), an Erasable Programmable Read-Only Memory (EPROM), an Electrically Erasable Programmable Read-Only Memory (EEPROM), a Flash Memory, a magnetic surface memory, an optical disk, or a CD-ROM (Compact Disc Read-Only Memory) and other memories, or various apparatuses comprising any one or any combination of the above memory devices.

In some examples, a computer program may be written in any form of programming language (comprising a compiled or interpreted language, or a declarative or procedural language) by adopting a form of a program, a software, a software module, a script or codes; and it may be deployed in any form, comprising deployed as an independent program or as a module, a component, a subroutine, or other cells suitable for use in a computing environment.

As an example, the executable instructions may, but do not necessarily, correspond to a file in a file system, may be stored in part of a file storing other programs or data, for example, stored in one or more scripts in a Hyper Text Markup Language (HTML) document, stored in single file dedicated for the discussed program, or stored in a plurality of cooperative files (e.g., the file for storing one or more modules, subprograms or code portions).

As an example, the computer program may be deployed on an electronic apparatus for execution, or on a plurality of electronic apparatuses at one site for execution, or distributed on a plurality of electronic apparatuses interconnected through a communication network at a plurality of sites for execution.

In some examples, referring to FIG. 9, FIG. 9 is a schematic diagram of a composition structure of a computer-readable storage medium provided by examples of the present application. The computer-readable storage medium comprises a first storage medium corresponding to the host 108, and a second storage medium corresponding to the memory system 102. When the computer program is performed by the memory device, the first storage medium may be configured to implement operations of the printing method of a binary log (which is mainly a method of offline printing) in the above-mentioned examples of the present application; and when the computer program is performed by the memory controller, the second storage medium may be configured to implement operations of the recording method and printing method (which is mainly a method of online printing) of a binary log in the above-mentioned examples of the present application.

In an eighth aspect, examples of the present application provide a computer program product. The computer program product comprises a computer program, and when the computer program is executed by a processor, the recording method provided in the fourth aspect, the printing method provided in the fifth aspect, or the printing method provided in the sixth aspect is implemented.

In some examples, the computer program product may be a program, software, a software module, a script, or codes, etc. stored in a memory device of various electronic apparatuses such as a personal computer, a tablet, a mobile phone, etc. Herein, the computer program of the computer program product may be understood by referring to the computer program stored in the computer-readable storage medium provided in the seventh aspect, and is not described herein again.

In view of this, examples of the present application provide a memory system, a system, a recording method and printing method of a binary log, a computer-readable storage medium, and a computer program product.

In a first aspect, examples of the present application provide a memory system. The memory system comprises: a memory configured to store a first instruction set for performing an operation for tracing an event during firmware running; and one or more processors coupled with the memory and configured to perform the first instruction set, wherein the first instruction set comprises instructions that are able to cause the memory system to perform at least the following operations: in response to triggering of a binary log comprising a plurality of event items, determining a timestamp and a format string describing an event, which are comprised in each of the plurality of event items, wherein the event items belong to events that occur during running of firmware in the memory system; and recording, as the binary log, at least a compilation address of a local static variable corresponding to the format string describing an event and the timestamp of each event item.

In some examples, each of the plurality of event items further comprises at least one parameter describing an event; and the binary log further comprises the at least one parameter describing an event.

In some examples, the format string describing an event is stored, in the form of the local static variable, in one section of an executable and linkable format (ELF) file in which the firmware is located.

In some examples, format strings describing different events correspond to compilation addresses of different local static variables.

In some examples, the first instruction set is implemented through a plurality of macros.

In some examples, the binary log is configured to perform failure analysis on the firmware.

In some examples, the memory comprises a non-volatile memory device; and the binary log is stored in the non-volatile memory device.

In some examples, the memory system comprises a memory card or a solid state disk.

In a second aspect, examples of the present application provide another memory system. The memory system comprises: a memory configured to store a second instruction set using a firmware event tracer, wherein the firmware event tracer comprises a plurality of event items, and the event items belong to events that occur during running of firmware in the memory system; and each event item comprises a timestamp and a format string describing an event; and one or more processors coupled with the memory and configured to perform the second instruction set, wherein the second instruction set comprises instructions that are able to cause the memory system to perform at least the following operations: in response to a print command of a binary log, obtaining the format string describing an event according to a compilation address of a local static variable corresponding to a format string in the binary log and in combination with a local static variable stored in an ELF file in which the firmware is located; and outputting the obtained format string and the corresponding timestamp together.

In some examples, each of the plurality of event items further comprises at least one parameter describing an event, and the at least one parameter describing an event is filled in a placeholder of the obtained format string describing an event; and when the obtained format string and the corresponding timestamp are outputted together, the filled format string and the corresponding timestamp are outputted together.

In a third aspect, examples of the present application provide a system. The system comprises: any one of the memory systems provided in the first aspect and the second aspect; and a host coupled with the memory system and configured to control the memory system.

In some examples, the host is configured to: acquire a binary log and a local static variable stored in an ELF file in which firmware is located, wherein a compilation address of the local static variable corresponds to a format string describing an event; based on the acquired local static variable, parse the compilation address of the local static variable in the binary log, so as to obtain the format string describing an event; and output the obtained format string and the corresponding timestamp together.

In some examples, each of the plurality of event items of the binary log further comprises at least one parameter describing an event, and the at least one parameter describing an event is filled in a placeholder of the obtained format string describing an event; and when the obtained format string and the corresponding timestamp are outputted together, the filled format string and the corresponding timestamp are outputted together.

In a fourth aspect, examples of the present application provide a recording method of a binary log. The recording method comprises: in response to triggering of a binary log comprising a plurality of event items, determining a timestamp and a format string describing an event, which are comprised in each of the plurality of event items, wherein the event items belong to events that occur during firmware running; and recording, as the binary log, at least a compilation address of a local static variable corresponding to the format string describing an event and the timestamp of each event item.

In a fifth aspect, examples of the present application provide a printing method of a binary log. The printing method comprises: in response to a print command of a binary log, obtaining the format string describing an event according to a compilation address of a local static variable corresponding to a format string in the binary log and in combination with a local static variable stored in an ELF file in which firmware is located, wherein the binary log comprises a plurality of event items, and the event items belong to events that occur during firmware running; and each event item comprises a timestamp and a format string describing an event; and outputting the obtained format string and the corresponding timestamp together.

In a sixth aspect, examples of the present application provide another printing method of a binary log. The printing method comprises: acquiring a binary log and a local static variable stored in an ELF file in which firmware is located, wherein a compilation address of the local static variable corresponds to a format string describing an event; the binary log comprises a plurality of event items, and the event items belong to events that occur during firmware running; and each event item comprises a timestamp and a format string describing an event; based on the acquired local static variable, parsing the compilation address of the local static variable in the binary log, so as to obtain the format string describing an event; and outputting the obtained format string and the corresponding timestamp together.

In a seventh aspect, examples of the present application provide a computer-readable storage medium. The computer-readable storage medium stores a computer program, and when the computer program is loaded and executed by a processor, the recording method provided in the fourth aspect, the printing method provided in the fifth aspect, or the printing method provided in the sixth aspect is implemented.

In an eighth aspect, examples of the present application provide a computer program product. The computer program product comprises a computer program, and when the computer program is executed by a processor, the recording method provided in the fourth aspect, the printing method provided in the fifth aspect, or the printing method provided in the sixth aspect is implemented.

In the examples of the present application, it is not needed for each log statement to be replaced with an identifier, and the local static variable is ingeniously utilized; since the compilation address assigned to the local static variable by a compiler is unique, after the compilation address is associated with the format string describing an event, the compilation address may serve as the identifier, such that the identifier does not need to be generated by an extra tool; meanwhile, in the examples of the present application, the compilation address of the local static variable can be obtained directly by compiling a source code without the need of extra processing such as modifying, replacing, scanning, etc. the source code, thereby greatly simplifying processes of using logs, and improving the convenience of tracing by firmware using logs; furthermore, in the examples of the present application, the timestamp of each event item and the compilation address of the local static variable corresponding to the format string describing an event are mainly saved, such that a data volume of logs is minimized.

It is to be understood that “one example” and “an example” mentioned in the whole specification mean that features, structures or characteristics related to the example is included in at least one example of the present application. Therefore, “in one example” or “in an example” appearing at any place of the whole specification does not always refer to the same example. In addition, these features, structures or characteristics may be combined in one or more examples in any proper manner. It is to be understood that, in various examples of the present application, sequence numbers of the above processes do not indicate an execution sequence, and an execution sequence of various processes shall be determined by functionalities and intrinsic logics thereof, and shall constitute no limitation on an implementation process of the examples of the present application. The above sequence numbers of the examples of the present application are only for description, and do not represent goodness and badness of the examples.

The above descriptions are merely preferred implementations of the present application, and not intended to limit the patent scope of the present application. Equivalent structure transformation made within using the contents of the specification and the drawings of the present application under the inventive concept of the present application, or direct/indirect application to other related technical fields are both encompassed within the patent protection scope of the present application.

What is claimed is:

1. A memory system, comprising:
a memory configured to store a first instruction set for performing an operation for tracing an event during firmware running; and
one or more processors coupled with the memory and configured to perform the first instruction set, wherein the first instruction set includes instructions that are able to cause the memory system to perform at least the following operations:
in response to triggering of a binary log including a plurality of event items, determining a timestamp and a format string describing an event, which are included in each of the plurality of event items, wherein the event items belong to events that occur during running of firmware in the memory system; and
recording, as the binary log, at least a compilation address of a local static variable corresponding to the format string describing an event and the timestamp of each event item.

2. The memory system of claim 1, wherein each of the plurality of event items further includes at least one parameter describing an event; and the binary log further includes the at least one parameter describing an event.

3. The memory system of claim 1, wherein the format string describing an event is stored, in the form of the local static variable, in one section of an executable and linkable format (ELF) file in which the firmware is located.

4. The memory system of claim 1, wherein format strings describing different events correspond to compilation addresses of different local static variables.

5. The memory system of claim 1, wherein the first instruction set is implemented through a plurality of macros.

6. The memory system of claim 1, wherein the binary log is configured to perform failure analysis on the firmware.

7. The memory system of claim 1, wherein the memory includes a non-volatile memory device; and the binary log is stored in the non-volatile memory device.

8. The memory system of claim 1, including a memory card or a solid state disk.

9. A memory system, comprising:
a memory configured to store a second instruction set using a firmware event tracer, wherein the firmware event tracer includes a plurality of event items, and the event items belong to events that occur during running of firmware in the memory system, and each event item includes a timestamp and a format string describing an event; and
one or more processors coupled with the memory and configured to perform the second instruction set, wherein the second instruction set includes instructions that are able to cause the memory system to perform at least the following operations:
in response to a print command of a binary log, obtaining the format string describing an event according to a compilation address of a local static variable corresponding to a format string in the binary log and in combination with a local static variable stored in an executable and linkable format (ELF) file in which the firmware is located; and
outputting the obtained format string and a corresponding timestamp together.

10. The memory system of claim 9, wherein each of the plurality of event items further includes at least one parameter describing an event, and the at least one parameter describing an event is filled in a placeholder of the obtained format string describing an event; and
when the obtained format string and the corresponding timestamp are outputted together, a filled format string and the corresponding timestamp are outputted together.

11. A system, comprising:
a memory system including:
a memory configured to store a first instruction set for performing an operation for tracing an event during firmware running; and
one or more processors coupled with the memory and configured to perform the first instruction set, wherein the first instruction set includes instructions that are able to cause the memory system to perform at least the following operations:
in response to triggering of a binary log including a plurality of event items, determining a timestamp and a format string describing an event, which are included in each of the plurality of event items, wherein the event items belong to events that occur during running of firmware in the memory system; and
recording, as the binary log, at least a compilation address of a local static variable corresponding to the format string describing an event and the timestamp of each event item; and
a host coupled with the memory system and configured to control the memory system.

12. The system of claim 11, wherein the host is configured to:
acquire a binary log and a local static variable stored in an executable and linkable format (ELF) file in which firmware is located, wherein a compilation address of the local static variable corresponds to a format string describing an event;
based on the acquired local static variable, parse the compilation address of the local static variable in the binary log, to obtain the format string describing an event; and
output the obtained format string and a corresponding timestamp together.

13. The system of claim 12, wherein each of the plurality of event items of the binary log further includes at least one parameter describing an event, and the at least one parameter describing an event is filled in a placeholder of the obtained format string describing an event; and
when the obtained format string and the corresponding timestamp are outputted together, a filled format string and the corresponding timestamp are outputted together.

14. The system of claim 11, wherein each of the plurality of event items further includes at least one parameter describing an event; and the binary log further includes the at least one parameter describing an event.

15. The system of claim 11, wherein the format string describing an event is stored, in the form of the local static variable, in one section of an executable and linkable format (ELF) file in which the firmware is located.

16. The system of claim 11, wherein format strings describing different events correspond to compilation addresses of different local static variables.

17. The system of claim 11, wherein the first instruction set is implemented through a plurality of macros.

18. The system of claim 11, wherein the binary log is configured to perform failure analysis on the firmware.

19. The system of claim 11, wherein the memory includes a non-volatile memory device; and the binary log is stored in the non-volatile memory device.

20. The system of claim 11, wherein the memory system includes a memory card or a solid state disk.
